(19) United States
(12) Patent Application Publication
(10) Pub. No.: US 2021/0221979 A1
(43) Pub. Date: Jul. 22, 2021

(54) PVA BOTTLES BIODEGRADABLE AND SOLUBLE IN HIGH TEMPERATURE WATER

(71) Applicant: BIO FUTURE WORLD LLC, Chestnut Hill, MA (US)

(72) Inventors: Ebrahim YAGHOUBI, Tehran City (IR); Mehdi ASADI, Sari Cty (IR)

(73) Assignee: BIO FUTURE WORLD LLC, Chestnut Hill, MA (US)

(21) Appl. No.: 17/260,200

(22) PCT Filed: Jul. 22, 2018
(86) PCT No.: PCT/IB2018/055447

§ 371 Date: Jan. 13, 2021

(51) Int. Cl. C08K 13/02; B65D 1/02; B65D 65/46

(52) U.S. Cl. CPC C08K 13/02; C08K 2201/018; B65D 65/466; B65D 1/0207

(57) ABSTRACT

The present invention discloses bottles and containers made up from polyvinyl alcohol composition that are biodegradable and soluble in high-temperature water which can be the best alternative to overcome the destructive effects of existing bottles and plastic containers wherein the said composition comprises water, polyvinyl alcohol, sodium hydroxide solution, stearyl alcohol, glycerine, talc powder as components of the composition.

### TECHNICAL FIELD

The fields of this invention are chemistry, polymer and environment.

### BACKGROUND ART

The most harmful type of pollution which is damaging to the environment is the use of bottles and plastic containers for packaging of liquids and other foodstuffs and chemicals. These types of bottle and plastic containers not only cause environmental pollution, but also endanger the lives of all creatures, and contaminate the water supply. Although these products are sorted as recyclables and are placed in special boxes after use, yet deep in nature this is just the beginning of a devastating and fatal experience for various species of animals. Clearly, this volume of plastic waste can have a devastating effect on nature and bring about long-term problems for plants, animals and humans.

Bottles and plastic containers are produced in a variety of ways, and according to their production process and use different types of materials such as high density polyethylene (HDPE), low density polyethylene (LDPE), polyethylene terephthalate (PET), polyvinyl chloride (PVC), polycarbonate (PC), polypropylene (PP) and polystyrene (PS) are used in their production.

HDPE is economical, impact resistant, and provides a good barrier for humidity. HDPE can be used in a wide range of products such as acids and bases, but it is not compatible with solvents.

LDPE is more flexible. It is less rigid and generally less chemically resistant than HDPE but is more translucent. LDPE bottles are generally used in high pressure processes, and they cost significantly higher compared to a HDPE.

The desirable properties of PET, including transparency, light weight, high strength, stiffness, low flavor absorption, high chemical resistance, barrier properties and low price make it the material of choice for making beverage bottles.

The main disadvantage of PET bottle is that, due to low strength in melting, the polyform is first produced, and then the polyform is subsequently converted to the bottle by the heat and pressure of the air. Also, recycling these bottles costs more than other bottles.

PVC is highly resistant to oil and lets very little oxygen pass. It is impermeable to most gases. Its mechanical strength is very good and it is resistant to chemicals. However, it has low resistance to some solvents. The biggest drawback of PVC is its low thermal resistance and melts at 71° C., and that is unusable for high temperature products.

PC's are suitable for water and milk packing.

Polypropylene has a high thermal resistance at high temperatures, that's why it is used for fill hot liquids or materials. Polypropylene has a very high resistance to chemicals, but at low temperatures it has low mechanical resistance.

PS is transparent and cost-effective, but it is not highly resistant to humidity, oxygen and so on. Also it has low mechanical resistance.

### SUMMARY OF INVENTION

Considering the advancements that humans has been experiencing over the past few years, today various types of polymer materials of different properties, are used intensively in the manufacture of packaging products and in other industries. Unfortunately, all of these products are causing environmental pollution. So far however no biodegradable products have replaced these polymer materials. Therefore, by developing a kind of biodegradable polymer which is soluble in water at different temperatures, we have produced a suitable alternative to replace all polymers. This new product is environmentally friendly, and water soluble. Moreover, it has no toxic effects.

### Technical Problem

Humankind has been experiencing great and rapid advancements over the past few years. These advancements embrace quite a wide range of fields as diverse as business, health, medicine, computer cars, clothing, and packaging. In the field of packaging industry and manufacture and production of containers and bottles, a variety of polymeric materials with a variety of properties are widely used, which unfortunately are harmful to the environment and extensive use of these types of containers and bottles has led to the growth and increase of waste and plastic garbage. At present, about 30% of waste generated in urban areas is plastic which is used in packaging food, and also in hygienic, medicinal and non-edible products. While high durability of plastics makes them such a convenient material for industry however these materials are highly resistant to degradation and last about 400 years to dissolve so they cause environmental pollution. On the other hand, recycling of these containers and bottles involves a great deal of problems and costs.

Some long-term effects of plastic pollution include:

1. Disruption of food chain: These massive plastic contaminants affect even the smallest organisms, such as planktons.

2. The damages to human beings resulting from use of plastic containers: Plastic containers mainly composed of petroleum and fossil materials. These materials can cause cancer when exposed to high temperatures above 65 ° C. or in the presence of lipids and acidic substances.)

3. Groundwater pollution: Underground water protection is one of the concerns of global population today, but underground water worldwide is at risk of plastic contamination. Many of the underground resources are contaminated with toxic materials leaks from plastic waste.

4. Contamination of the Earth: When plastic waste is released into nature, it reacts with water and releases hazardous chemicals. These chemicals cause soil and water pollution. Moreover the wind moves the remnants of plastic materials to other places as well, causing contamination on the earth surface. And these contaminations can lead to death of plants and animals.

5. Air pollution: Smoke from the burning of plastic materials in the open air generates toxic substances and causes air pollution. Air pollution caused by fuel materials, in addition to breathing problems in humans, causes a lot of problems in other animals and increases greenhouse gases concentration.

6. Contamination caused by plastic containers brings about animal deaths: Despite various television programs showing birds trapped in plastic containers, or dolphins stuck in plastic bags released to nature, we are still witnessing animals getting in trouble with these wastes.

7. The process of making, storing and disposing of plastic can have serious and important impact on all organisms on earth.

8. A lot of costs goes annually to the disposal of these wastes and the elimination of the effects of these plastic materials on the lives of animals, plants and humans.

### Solution to Problem

The best solution to overcome all the problems resulting from use of plastic containers is to use materials that are environmentally friendly. Bottles and containers made from degradable materials can rapidly degrade in soil, so they do not generate environmental effects, and since these products do not interact with food, so they can be used for packaging food, liquids, Oils and even chemicals. Because of the nature of the ingredients composing (polyvinyl alcohol), chemical toxic substances do not enter into food which is contained in biodegradable disposable bottles and plastics containers, so neither they endanger the health of individuals and nor do they pollute the environment. Polyvinyl alcohol (PVA) is a synthetic polymer soluble in water and has biodegradable property. In other words Vinyl alcohol monomers are weak and PVA is prepared by replacing the acetate group in vinyl acetate with hydroxyl groups; which the presence of water or air humidity leads to its biological degradation.

Polyvinyl alcohol has a continuous process for production that results in production of a product with hydrolysis of over 80%. The degree of polyvinyl alcohol hydrolysis affects its properties, such as surface tension, compatibility, kinetics, rheology and solubility in water.

### Advantageous Effects of Invention

1. It is Biodegradable

2. It is Soluble in high temperature water

3. It is Printable.

4. It can be produced in different types and sizes

5. It is Environment friendly

6. It exhibits high mechanical strength

7. It has High thermal resistance

8. It has Suitable price

9. It doesn't have hazardous chemicals

10. It doesn't need to recycle

11. Easy and cost-free recycling when needed

### BRIEF DESCRIPTION OF DRAWINGS

FIG. 1

[symbol]

### DESCRIPTION OF EMBODIMENTS

### EXAMPLES

PVA with a degree of hydrolysis of 90% is used to produce high-temperature water-soluble bottles or biodegradable containers. 1000 g of the PVA is heated and stirred in 1000 g of water at 60° C. for 20 minutes. Then 150 g of 1 M Sodium hydroxide solution is added as catalyst to the obtained PVA gel. To improve the properties of the final product, 200 grams of Stearyl alcohol and 50 g of Glycerin are added to the mixture as a plastisizer. The mixture is stirred for 70 minutes at 80° C. To increase the mechanical property of these products, 70-140 g of powdered Talc is added and stirred at the same temperature for 30 minutes. The obtained gel has a high viscosity, but the product has very good physical properties and has a high dissolution resistance in low temperature water.

The obtained gel is transferred to the injection machine to produce the bottle, and followed by the injection process the bottle is produced using different molds in different shapes and sizes, with respect to their type of use.

### INDUSTRIAL APPLICABILITY

PVA bottles are biodegradable, soluble in high-temperature water and easily decomposed and restored in nature. Hence, in order to maintain an industrial support for sustainable development and the conservation of natural habitats, the production of a new generation of polymeric materials is on the agenda of many advanced countries and has a special stance. The use of PVA bottles in the food, pharmaceutical, agricultural and other industries has attracted the attention of manufacturers and consumers of these products.

### REFERENCE SIGNS LIST

### Reference to Deposited Biological Material

### Sequence Listing Free Text

### CITATION LIST

### Patent Literature

PTL1:

### Non Patent Literature

1. The biodegradable and soluble in high temperature water bottles made of polyvinyl alcohol” with the following components:

| | |
|---|---|
| 1. Water | 40% |
| 2. Polyvinyl alcohol | 40% |
| 3. Sodium hydroxide solution 1M | 6% |
| 4. Stearyl alcohol | 8% |
| 5. Glycerin | 2% |
| 6. Talc powder | 4% |

2. In the combination of the ingredients mentioned in claim No. 1, water is used as the main solvent.

3. In the combination of ingredients mentioned in claim No. 2, 90% of polyvinyl alcohol is used as a base material which is biodegradable and water-soluble.

4. In the product obtained in claim No. 3, sodium hydroxide solution is used as a catalyst.

5. In the product obtained in claim No. 4, the combination of stearyl alcohol and glycerin is used as the Plasticizer substance.

6. In the product obtained in claim No. 5, talc powder is used to increase the mechanical properties.

7. The gel obtained in claim No. 6 is for produce bottles and containers that are biodegradable and soluble in hot water at temperatures above 80° C.

8. The products mentioned in claim No. 7 are quickly solved in water.

9. The products mentioned in claim No. 8 can easily decompose in the environment and in normal conditions.

10. The products mentioned in claim No. 9 are soluble in hot water at temperatures above 80° C.

11. The products mentioned in claim No. 10 do not release any harmful and poisonous residue when decomposed and dissolved in water.

12. The products mentioned in claim No. 11 are completely biodegradable.

13. The products mentioned in claim No. 12 are only soluble in water at temperatures above 80° C. and have a very high resistance to chemical solvents, oils, and so on.

14. The innovative strength point of this invention is the decomposition speed, the ability to decompose in water at a specified temperature without damaging the environment. Also, these types of bottles are suitable for packing types of food, types of liquids,chemicals,oils, agriculture.
